(19) United States
(12) Patent Application Publication
(10) Pub. No.: US 2003/0019654 A1
(43) Pub. Date: Jan. 30, 2003

(54) Cord organizer

(76) Inventor: James P. Merritt, Houston, TX (US)

Correspondence Address: FULBRIGHT & JAWORSKI, LLP, 1301 MCKINNEY, SUITE 5100, HOUSTON, TX, 77010-3095, US

(21) Appl. No.: 09/912,620

(22) Filed: Jul. 24, 2001

(51) Int. Cl. H01B 3/00

(52) U.S. Cl. 174/72 A

(57) ABSTRACT

The cord organizer of the present invention is made up of a hollow container, preferably rectangular-shaped, having a top surface and a bottom surface. The container is divided into at least one longitudinal section by vertical longitudinal dividers. The top surface of the container includes longitudinal slits centered over the longitudinal sections so that a user can line up each cord along one of the slits and firmly press the cord down through the slits into the longitudinal channel.

### FIELD OF THE INVENTION

The present invention relates generally to an organizer for cords, such as electrical, telephone and data cords, that keeps the cords free from tangles and hides them.

### BACKGROUND OF THE INVENTION

Millions of appliances and computers are in use in industrialized society, not only in industry, but in offices, schools, and households as well. Each appliance or computer and computer devices requires its own cord, electric and data cords, that travels from the appliance or the computer to the electric outlet and other devices. These cords sometimes reach a considerable distance. This can make for an unattractive amalgam of tangled cords travelling across rooms from the appliance or computer to the electric outlet or other devices. Further, tangled cords can lead to damage to the cords themselves, thus limiting the life of the electric appliance or computer.

A known electric cord holder is described in U.S. Pat. No. 4,454,374, which discloses a tubular cord cover with a C-shaped cross-section having only one compartment for electric cords, formed by extruding plastic. Another electric cord holder is described in U.S. Pat. No. 3,118,017, which discloses a floor conduit to cover and protect electric cords, where the cords must be pressed in from the bottom of the device. Thus, the user must lift the conduit, and then press the electric cords up into the conduit.

There are also several patents on reel cord organizers where the excess electric cord is wound around reels and other parts of the invention. See, for example, U.S. Pat. Nos. 6,164,582 titled “Enhanced Storage System for Electrical Appliances, Powercords, and Adapters” and 3,626,495 titled “Tangle Free Wire Holder”.

It would be desirable to provide a cord organizer made of a flexible material, so the cords can be pressed into the channels of the organizer and out of plain view. It would also be desirable to provide an organizer that has multiple channels and also provides an attractive storage container for the cords while in use.

### BRIEF SUMMARY OF THE INVENTION

The present invention is directed to a cord organizer, preferably rectangular-shaped. The organizer is made up of a container and, optionally, a cover. The container is hollow and is divided into longitudinal sections by vertical dividers. These longitudinal sections are accessible by slits formed in the top of the container. The optional cover fits onto the top of the container, covering the slits.

An object of the invention is to provide an inexpensive, effective cord organizer that can be used in a variety of places and comes in a variety of sizes.

The inventive organizer can be constructed either through injection molding, compression molding, or extrusion from a flexible material, such as plastic (in particular polypropylene resin or low-density polyethylene), or other material having substantially similar flexibility and durability properties.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a perspective view of the present invention, including the container and the optional cover;

FIG. 2 is a top plan view of the optional cover for the invention;

FIG. 3 is a side plan view of the optional cover for the invention;

FIG. 4 is an end plan view of the optional cover for the invention;

FIG. 5 is a top plan view of the container showing the outline of the channels;

FIG. 6 is a side plan view of the container showing the outline of the channels;

FIG. 7 is a side cross-sectional view of the container;

FIG. 8 is a top plan view of two containers, illustrating a ninety-degree turn; and

FIG. 9 is a side cross-sectional view of the container.

### DETAILED DESCRIPTION OF THE INVENTION

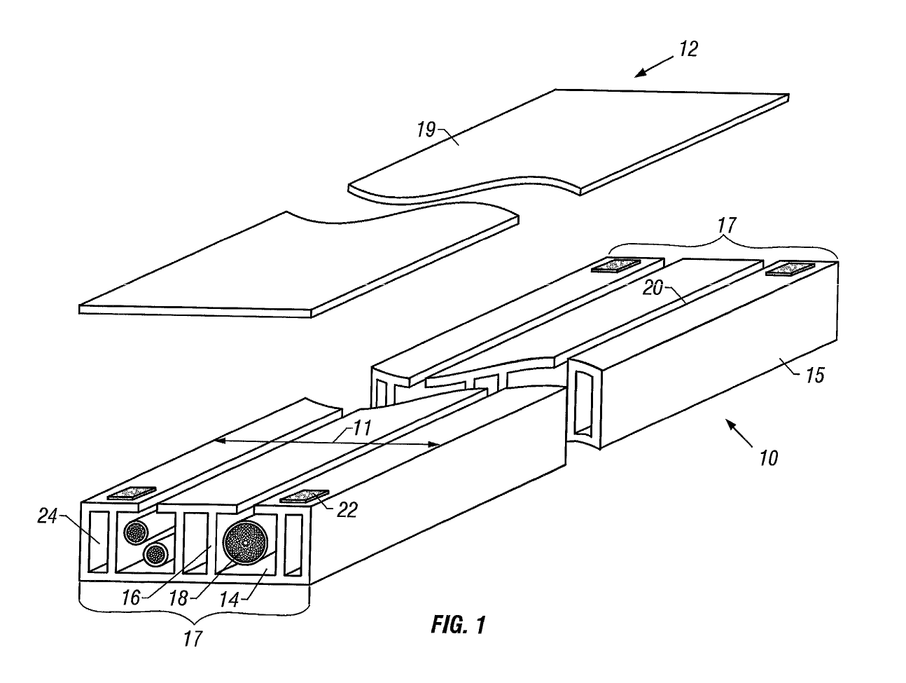

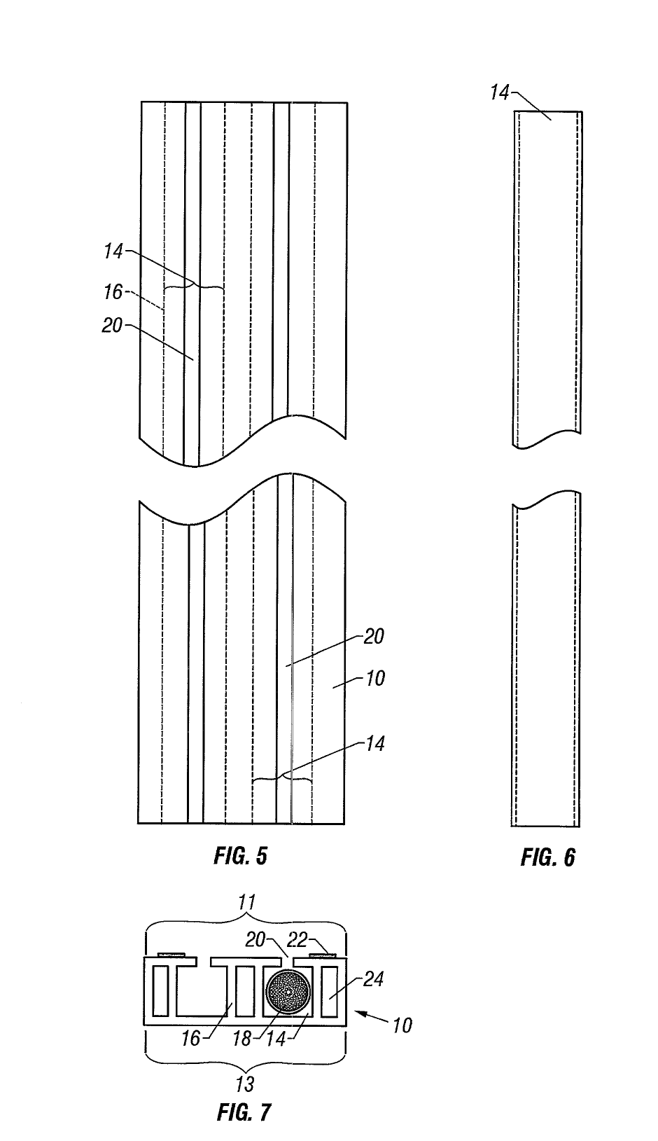

The present invention is directed to a cord organizer that provides an attractive storage container that keeps cords tangle-free. The cord organizer is configured for all kinds of cords and cables such as electrical, telephone, data transmission cords, computer cables and the like. The organizer is made up of a hollow container 10 and an optional cover 12. The container includes a top surface 11, bottom surface 13, longitudinal sides 15 and parallel ends 17, as shown in FIG. 1. The container has longitudinal (i.e. parallel to the long sides 15 of the invention) channels 14, defined by vertical longitudinal dividers 16, as shown in FIG. 1 and FIGS. 5-7. The channels 14 can accommodate a number of cords and cables 18. These longitudinal channels are accessible through slits 20 formed in the top surface 17 of the container 10, the slits 20 being centered over the longitudinal channels 14, as shown in FIG. 1 and FIGS. 5-7. In one embodiment, the container 10 has open spaces 24 between the long sides 15 and the outermost vertical dividers 16, as shown in FIG. 1 and FIG. 7; however, in an alternate embodiment, the container can be formed without these open spaces 24 (see FIG. 9). Preferably, container 10 is made of a flexible material. Thus, the user lines up each cord 18 along one of the slits 20 and firmly presses down on the cord 18, causing the slits 20 to give and allowing the cord 18 to be pushed into the longitudinal channel 14 (see FIG. 1.)

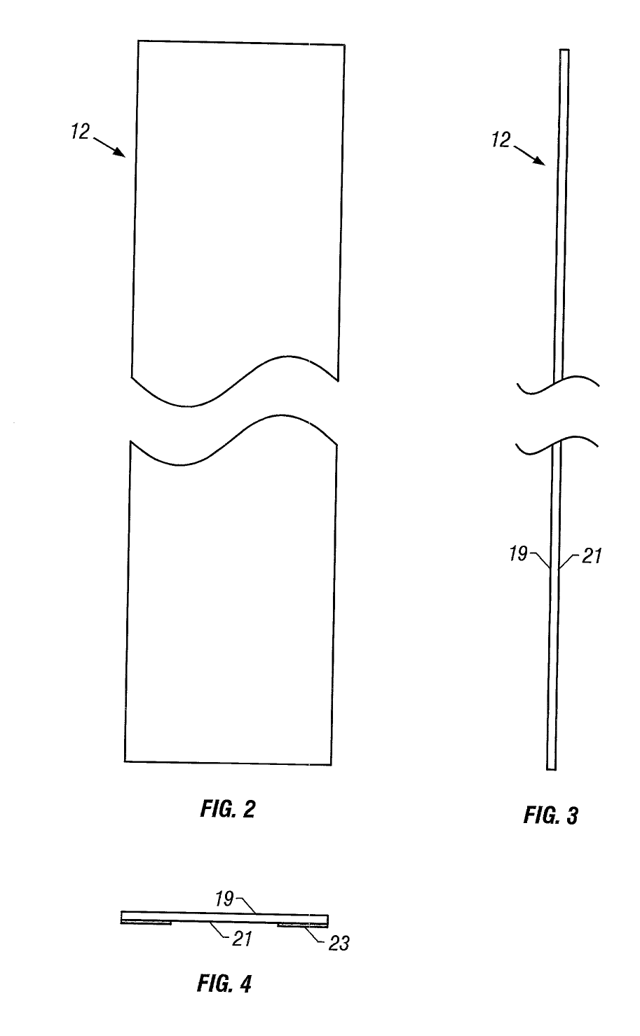

The optional cover 12 includes an outer surface 19 and an inner surface 21. The optional cover 12 fits on top of the container 10, covering the slits 20. The optional cover 12 can be attached to the container 10 with a cover-securing means 23, such as an adhesive strip or strips of hook and loop fasteners. The cover-securing means 23 is attached to the inner surface 21 of the cover 12. The cover-securing means 23 mates with a cover-receiving surface 22 on the container 10. See FIGS. 2-4.

The invention can be formed out of plastic, particularly polypropylene resin or low-density polyethylene, or other flexible material by injection molding, compression molding, or extrusion. Injection molding is a manufacturing process where heated plastic is forced into a mold cavity under pressure. A mold cavity is essentially a negative of the part being produced. The cavity is filled with the melted plastic, and the plastic changes phase to a solid, resulting in the product. The invention can be manufactured by injection molding techniques known to one skilled in the art of injection molding.

With compression molding, the mold has a top portion and a bottom portion. A defined quantity of material is put between the top portion and bottom portion of the mold. The mold closes, so that the top portion meets the bottom portion, which pushes the material into the mold cavity. Compression molding is most often used with cross-linked polymers. Gerd Pötsch & Walter Michaeli, Injection Molding: An Introduction 184 (Hanser Publishers, 1995). The invention can be manufactured by compression molding techniques known to one skilled in the art of compression molding.

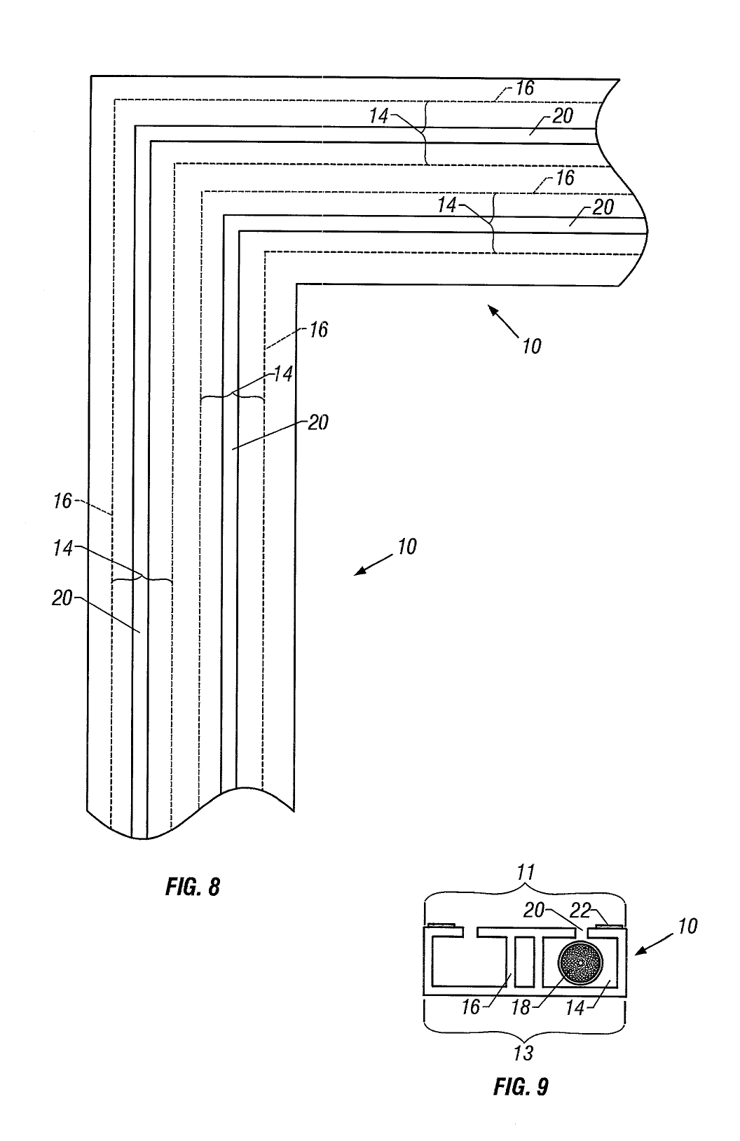

In one particular embodiment, two containers with ends cut at forty-five degree angles, with respect to the longitudinal axis, can be joined at approximately a ninety-degree angle. This is best seen in FIG. 8, which shows two containers 10 to be joined to one another so as to form an L-shaped configuration. Another container 10 could be added on to form a U-shaped configuration. In another embodiment, the end of the container 10 can be shaped at approximately a forty-five degree angle with respect to the latitudinal axis (which is parallel to the parallel ends 17 of the container 10), so that one container 10 can extend, for example, along an upright wall, and the other container 10 with an end cut similarly to be joined thereto at right angles can extend, for example, along the floor.

The invention can be freestanding, or can be attached to a wall or desk with a securing means, for example, an adhesive strip or screws.

In a preferred version of the invention, channels 14 can be generally about 1 to 3 inches wide. The corresponding slits 20 can be generally about 1/4 to 1 inch wide. In the invention shown in FIG. 7, the open spaces 24 can have a width of generally from 1/2 to 1 inch. The invention can be provided in a variety of lengths, preferably between 1 to 3 feet and in widths of 4 to 12 inches or wider. The number of channels 14 is preferably two, but container 10 can include additional channels 14.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A cord organizer comprising:
a hollow container having a top and bottom surface, two longitudinal side surfaces and parallel end surfaces, the container being formed from a flexible material
the container being divided into at least one longitudinal section by vertical longitudinal dividers;
the top surface including a longitudinal slit positioned centrally over each of the at least one longitudinal section;
wherein the container is sized and shaped to hold a plurality of cords.

2. The organizer of claim 1, further comprising a cover having a outer surface and an inner surface, the cover being sized and shaped to substantially extend over the top surface of the container.

3. The organizer of claim 2, wherein the inner surface of the cover further includes securing means for securing the cover to the top surface of the container.

4. The organizer of claim 1, wherein the at least one longitudinal section defines a channel for holding at least one of the plurality of cords.

5. The organizer of claim 1, wherein the container includes two longitudinal sections forming two channels for holding the plurality of cords.

6. The organizer of claim 1, wherein the cords are selected from a group consisting of electrical cords, telephone cords, data transmission cords, cables, and computer cables.

7. The organizer of claim 1, wherein the container is formed from a flexible material having a flexibility that allows the cords to be pushed through the slits and into the longitudinal sections.

8. The organizer of claim 1, wherein the container is formed from a polypropylene resin or low-density polyethylene material.

9. The organizer of claim 1, wherein the container is rectangular shaped.

10. The organizer of claim 1, wherein the contained is manufactured from a process selected from a group consisting of injection molding, compression molding and extrusion.

11. The organizer of claim 1, wherein the longitudinal sections is generally about 1 to 3 inches wide.

12. The organizer of claim 1, wherein the longitudinal slit is generally about 1/4 to 1 inch wide.

13. The organizer of claim 1, wherein the container has a width of generally about 8 to 12 inches.

14. The organizer of claim 1, wherein the container has a length of generally about 2-3 feet.

15. The organizer of claim 1 wherein a first and second container each define an opposing longitudinal axis and each has an opposing end sloping at an angle of about forty-five degrees with respect to its longitudinal axis, whereby the first and second containers can be joined together to form an approximate right angle.

16. A cord organizer comprising:
a hollow rectangular container made from a flexible material having a top surface and a bottom surface, wherein the top surface is covered with a detachable cover;
the container having one or more ends is configured to form a ninety-degree angle;
the container being divided into longitudinal sections by vertical longitudinal dividers forming channels;
the top surface including longitudinal slits over the channels, wherein the longitudinal slits are narrower than a width of the channels; and
securing means to attach the organizer to an external surface.
